(19) United States
(12) Patent Application Publication
(10) Pub. No.: US 2007/0201641 A1
(43) Pub. Date: Aug. 30, 2007

(54) Information verification in a telecommunications network

(75) Inventors: Eytan Bar, Even Yehuda (IL); Yossi Brikman, Herzliya (IL); Omer Gotlieb, Even Yehuda (IL)

Correspondence Address: PEARNE & GORDON LLP, 1801 EAST 9TH STREET, SUITE 1200, CLEVELAND, OH, 44114-3108, US

(73) Assignee: MTS MER TELEMANAGEMENT SOLUTIONS LTD., Ra'anana (IL)

(21) Appl. No.: 10/598,868

(22) PCT Filed: May 18, 2004
(86) PCT No.: PCT/IL04/00420

§ 371 Date: Sep. 14, 2006

(51) Int. Cl. H04M 15/00

(52) U.S. Cl. 379/114.03

(57) ABSTRACT

A method and apparatus for bill verification in a communication and computing environment is disclosed. The apparatus includes a user device (12, 14, 16) and a bill verification device (26). The user device independently generates user data records (36) that describe usage units of a service and transmits (42) the user data records to a bill verification device (26). The bill verification device collects bill calculation information from a user device, from a service provider device (18) and a service provider billing system and independently calculates and generates a bill with embedded inter-bill difference indicators. The bill verification device is further used as a post-billing usage control mechanism.

### BACKGROUND OF THE INVENTION

1. Field of the Invention

The present invention relates generally to the field of telecommunication networks. More specifically, the present invention relates to bill verification in mobile telephony networks in order to ensure that service subscribers are appropriately billed for the services used.

2. Discussion of the Related Art

Mobile service providers typically bill their subscribers directly for the services provided. The bills are prepared periodically, typically once a month, where the billing calculations are based on service usage units or service transactions performed by the subscriber during the billed month. The billing calculations are further based on the types of the service provided and on pre-determined payment policies, terms, and conditions associated with the service subscription and/or service agreements or service contracts decided upon and confirmed both by service provider and the subscriber. A critical issue facing mobile telephone subscribers is to make sure that the bills prepared by the service provider are appropriate and no billing errors exist. For example, it is important for the subscriber to see the received bills in order to make sure that bills include only services that were used. To check and verify manually a detailed service usage bill, such as a monthly mobile telephone bill, or a periodical credit card bill could be a difficult task for a typical subscriber especially where the number of charged items associated with specific service types (such as, for example, access fee), service usage units or service transactions is large. Bills typically include a large number of chargeable items and therefore could be complex documents loaded with a vast amount of information. For example, a typical mobile telephone bill displays all the calls that were placed and received during the period of the bill. In addition the airtime and long distance charges for each call are provided. The call information includes date and time, call destination, number called, rate period, duration of call in minutes, airtime rate, airtime charge, long-distance charge (if applicable) and total charge of the call. When the subscriber has a consolidated account (an account with more than one mobile device) the bill further includes totals by each device, such as total airtime, long distance roaming, and other charges (monthly charges, taxes, and the like). If the mobile telephony service plan has more than one rate or rate period, a separate line appears for each rate in which minutes were used.

Considering the fact that groups of subscribers could have substantially unique service agreements and the fact the service agreement includes complex interrelations between various terms, conditions, and limitations supposed to be activated following a differential number of all calls, service types, and the like, it would be easily perceived by one with ordinary skills in the art that the accurate verification of a complex mobile bill is a difficult time-consuming task for an individual subscriber handling even a single monthly bill. It is even a more difficult task for an enterprise that is typically having one or more consolidated accounts that includes a plurality of bills or sub-bills where each bill concerns a distinct user device used by one of the employees of the enterprise. Thus, there is an urgent need to provide an apparatus and method that would allow for automatic, reliable, precise, time-optimized, and convenient bill verification in a mobile telephony service and other billable services, such as credit card services.

### SUMMARY OF THE PRESENT INVENTION

One aspect of the present invention regards an apparatus for verifying one or more service bills issued to one or more subscribers by a service provider in a communications and computing environment. The apparatus comprises the elements of: a user device connectable to a communications network, associated with one or more subscribers, generating user data records describing usage units of a service provided by the service provider and transmitting the generated user data records for bill verification, and a bill verification device linked to the communications network for storing and collecting bill calculation and generation information from the user device and from one or more service provider devices linked to the communications network, and for calculating and generating a comparison bill, for comparing the calculated and generated comparison bill with the service usage bill issued by the service provider. The objective of the apparatus is to verify the service usage bills issued by the service provider. The verification process could utilize the various billing parameters provided by a user.

A second aspect of the present invention regards a method for verifying a service usage bill associated with a service, such as a mobile telephony service, and issued to a subscriber by a service provider in a communication and computing environment. The method comprises the steps of: generating a service usage log file in the user device as a result of service usage, building the user data record from the service usage log file in the user device, the content of the record reflecting one or more usage units associated with a service provided by the service provider, activating a data transmission process via a scheduling component or manually for providing periodic user data record transmission from the user device to a bill verification device, transmitting the user data record to the bill verification device from the user device, receiving a service usage bill from a service provider billing system in the bill verification device, requesting and receiving service usage bill calculation and bill generation control data from the service provider billing system in the bill verification device, generating a comparison bill based on the bill calculation and generation control data in the bill verification device, comparing the comparison bill with the service usage bill in the bill verification device, determining differences between the comparison bill and the service usage bill in the bill verification device, and generating difference indicators and merge the comparison bill and the difference indicators into a verification bill in the bill verification device.

### BRIEF DESCRIPTION OF THE DRAWINGS

The present invention will be understood and appreciated more fully from the following detailed description taken in conjunction with the drawings in which:

FIG. 1 is a schematic illustration of a communication and computing environment in which the present invention could operate;

FIG. 2 is a schematic illustration of components constituting the user device, in accordance with the first preferred embodiment of the present invention;

FIG. 3 is a schematic illustration of an exemplary service provider device and an exemplary service provider billing system, in accordance with the first preferred embodiment of the present invention;

FIG. 4 is a schematic illustration of an exemplary bill verification device, in accordance with the first preferred embodiment of the present invention;

FIG. 5A is a flowchart describing the an exemplary method operating on the user device, in accordance with the first preferred embodiment of the present invention;

FIG. 5B is a flowchart describing the initial handling of the user data records on the bill verification device, in accordance with the first preferred embodiment of the present invention; and

FIG. 6 is a flowchart describing an exemplary bill verification process, in accordance with the first preferred embodiment of the present invention.

### DETAILED DESCRIPTION OF THE PREFERRED EMBODIMENTS

The present invention concerns a method and an apparatus for bill verification in a communication and computing environment. A user device operated by a subscriber and connected to a communications network or a data network through which the user device receives and utilizes services provided by a service provider, such as a mobile telephone service provider or a credit service provider, independently generates user data records that describe usage units of the service provided that were utilized by the subscriber. The usage unit can be a pre-defined period of a cellular telephony call, an SMS message, an MMS message, a predetermined size of data packet, a charge on a bill, the use of a particular utility or service which can be predetermined in units, and later billed to a user. The structure and constituent fields of the user data records are substantially similar to the call data records or other similar service data records generated by a service provider device operating in the network. The user data records are transmitted on a periodic basis or on request from the user device to a bill verification device. The bill verification device is optionally linked to the communication network. The bill verification device receives bill calculation information and subscriber information from a) the user device, b) the service provider device and, c) a service provider billing system. Based on the user data records received from the user device and on the diverse aggregated billing and subscriber information the bill verification device independently calculates and generates a comparison bill. The comparison bill is compared to a service bill or to data comprising a service bill received from the service provider billing system. Difference indicator data is generated that indicates the discrepancies between the comparison bill and the service bill. The comparison bill and the difference indicators are merged into a verification bill. The verification bill with the embedded difference indicators is utilized by bill examiners, such as an individual subscriber or enterprise personal for verifying the information displayed by the service bill. Alternatively, the difference indicator data is presented to the user or is used to generate a difference report.

The bill verification device is further used as a post-billing usage control mechanism. Usage rules and usage limitations associated with a specific subscriber and/or a specific subscriber group concerning the utilization of the user device usage within an organization are pre-defined and stored on the bill verification device. The usage rules concern specific subscriber-specific or subscriber group-specific post-billing usage limitations, such as the maximum number of service usage units that a subscriber is allowed to exploit consequent to the billing. The rules are further associated with pre-defined actions that define the type and the course of an action that is to be taken as a result of certain post-billing conditions delineated by the billing results and by the rules and limitations definitions. The rules are processed in association with the subscriber data in order to examine whether any rule-specific conditions arise that justify the activation of an associated action. Thus, for example, when it is determined that the amount and/or length of service usage units utilized by a user device has a pre-defined limit number, the action could involve the generation of an action indicator that will appear on the verification bill, and could involve additional measures, such as the optional blocking of the account, the optional transfer of suitable notification to pre-defined management personnel, and the like. One non-limiting example is for a cellular telephony user to have no more than 10 minutes of call time and fifty SMS messages approved per month.

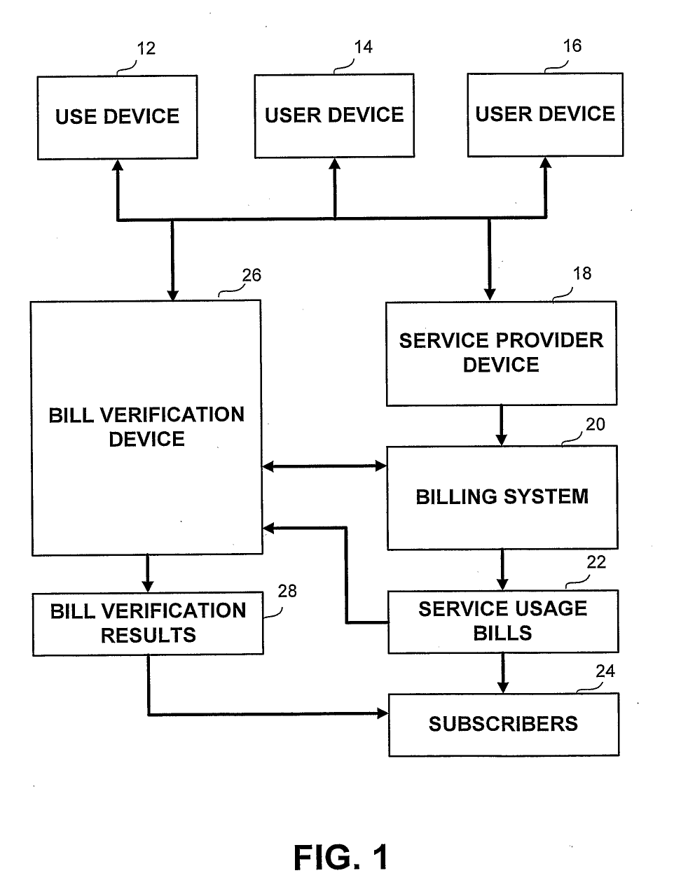

Referring now to FIG. 1 that illustrates an exemplary communication and computing environment in which the present invention could operate. User devices 12, 14, 16 are mobile user devices that are used and operated by service subscribers. In the first preferred embodiment of the present invention, devices 12, 14, 16 are mobile telephony devices, such as mobile telephone devices, Personal Digital Assistants (PDAs) or any other mobile device with communication capabilities. Devices 12, 14, 16 are communicatively linked to a communications network, such as a mobile telephony network and a data communication network, such as a LAN, a WAN, and the like. For example, as a WAN the Internet and more specifically the World Wide Web could be used. In the first preferred embodiment of the present invention, devices 12, 14, 16 are intermittently and communicatively connected to a service provider device 18 in order to receive and utilize services offered by a service provider. The service offered is a mobile telephony service, the service provider is a Mobile Telephony Service Provider, and the service provider device 18 is a mobile telephony switch. The service provider device 18 receives requests for telephony or data service from the devices 12, 14, 16, establishes the requested telephony or data links between the devices 12, 14, 16 for allowing the performance of a telephone call or a data exchange session, and manages and controls the performance of the telephone call or data exchange session. Based on the parameters of the user device participating in the call and on the call parameters, the service provider device 18 generates call data records that include user device-specific, and call-specific or session-specific information. The call data records are stored on the service provider device. Periodically the service provider device 18 transfers the accumulated call data records to a billing system 20 on a periodic basis for the purpose of service bill preparation. The billing system 20 is a logically interconnected set of computer programs and associated control data structures operative in the preparation of service usage bills 22 where the calculations involved in the bill preparation are based on the call data records received from the service provider device 18 and on diverse pre-defined billing control information that includes subscriber-specific information, such as subscriber service agreements, and the like. The prepared service usage bills 22 are distributed to the suitable subscribers 24 in order to enable the subscribers to check the bills and pay for the bills. The structure and the content of the service usage bills 22 provides detailed information about the service usage units utilized by the subscribers 24 in the period covered by the service usage bills 22.

Still referring to FIG. 1 user devices 12, 14, 16 generate user data records during the utilization of the service provided. The user data records represent service usage units and are substantially similar to the call data records generated by the service provide device 18. The user data records are periodically transmitted to a bill verification device 26 on a periodic basis. In the first preferred embodiment of the present invention, the bill verification device 26 is a logically interconnected set of computer programs and associated control data structures. The bill verification device 26 could be installed on a dedicated or shared computing platform directly linked to the data communication network and indirectly linked via suitable gateway devices to the mobile telephony communications network. The computing platform hosting the bill verification device 26 could operate within the framework of an enterprise providing bill verification services to the enterprise employees and managers. The bill verification device 26 could alternatively operate as an Internet server associated with an Internet site providing bill verification services to a plurality of individuals, small businesses, offices, organizations, and the like. The bill verification device 26 is responsible for the independent preparation of comparison bills based on a) the user data records received from the user device 12, 14, 16, b) on service usage bills 22 obtained from the billing system 20, and c) on additional information stored in the control data structures, such as subscriber information, service provider billing control information, and the like. Based on the independently prepared comparison bills, the service usage bills, and on additional control information, the bill verification device 26 produces bill verification results 28. Results 28 are distributed to the suitable bill examiners, such as subscribers 24, management personnel, and the like. By examining the results 28 the subscribers 24 are made aware of potential billing errors in the service usage bills 22. Users could also manage usage and keep the service providers alerted to inconsistencies in billing or service plan rules. Note should be taken that although the drawing under discussion shows only a limited number of user devices, a single service provider device, and a single bill verification device, it would be easily perceived that in a realistic environment a plurality of user devices could be serviced by a plurality of services provider devices and a plurality of bill verification devices. Further note should be taken that the above-described communication and computing environment is exemplary only. In other preferred embodiments of the present invention, diverse other devices could be utilized, such as an authentication and authorization device, and the like.

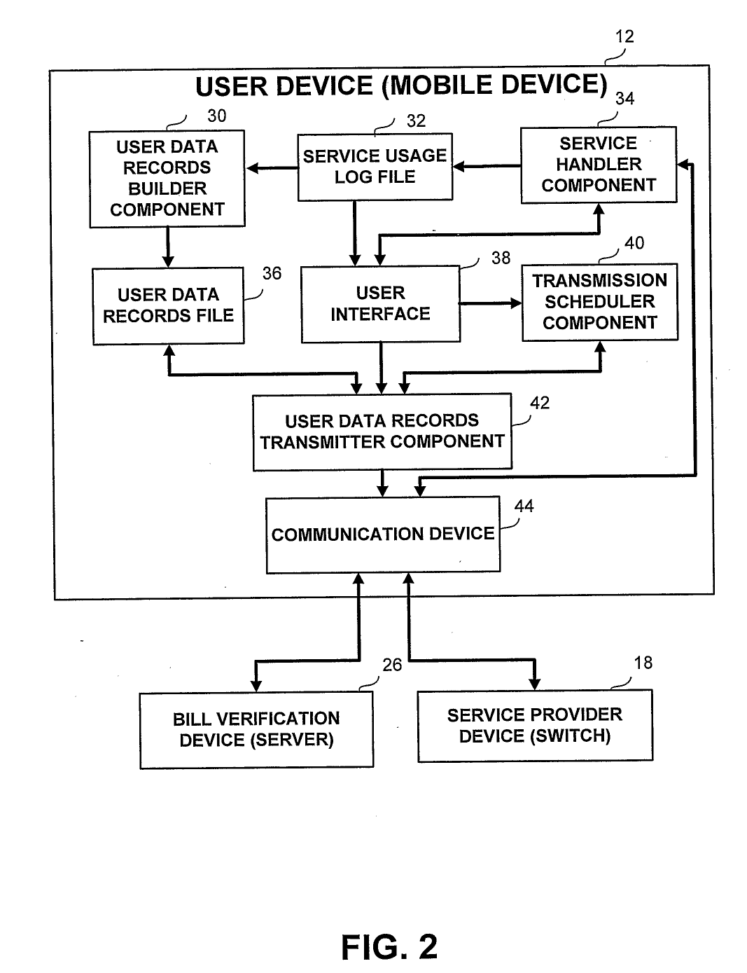

Referring now to FIG. 2, in the first preferred embodiment of the present invention, user device 12 is a mobile telephony device utilized and operated by a mobile telephony service subscriber. Device 12 is linked intermittently and communicatively to a service provider device 18 and a bill verification device 26 via standard communication channels, such as an air interface, coaxial cables, optic fiber links, infra red links, satellite links, and the like. The connection could be established in a continuous manner or could be established on a needed basis. In the first preferred embodiment of the present invention, the service provider device 18 is a mobile telephony switch, and the bill verification device 26 is a bill verification server installed on a computing platform within a data communications network. Device 12 includes a service handler component 34, a user interface 38, a service usage log file 32, a user data records (UDR) builder component 30, a user data records (UDR) file 36, a transmission scheduler component 40, a user data records (UDR) transmitter component 42, and a communication device 44. Service handler component 34 is responsible for the handling of service requests submitted by the subscriber of the device 12. As a non-limiting example handler component 34 could receive a sequence of signals representing a series of coded digits and a signal representing a coded connection request from the subscriber of the user device 12 via the user interface 38. As a result the handler component 34 will transmit the sequence of digits to the service provider switch 18. The switch 18 will construe the digits as a telephone number and will attempt to set up a call between the user device 12 and a telephone device linked to the telephony network. Handler component 34 transmits service requests to the service provider device 18 and receives service from the service provider device 18 via the communication device 44. Handler component 34 further responsible for the opening of service sessions, the managing of service sessions, and for the termination of service sessions in the user device 12 in association with the service provider device 18. In addition service handler component 34 is responsible for the creation of the service usage log file 32. The service usage log file 34 is coupled to the service handler component 34 and includes basic log records representing service usage units associated with the service session. One or more log records are built for each service session performed. An exemplary log record could include service session data, such as length of call, telephone number called, and the like. User interface 38 is responsible for the establishment of the internal communication between the operative components of the user device 12 and the subscriber operating the device 12. User interface 38 allows the subscriber to activate the service handler 34, to submit call requests, to receive responses, and the submit session commands. User interface 38 further allows for inputting of the transmission scheduling parameters to the transmission scheduler component 40. User interface 38 further provides the option of activating user data records transmission manually by the activation of an external control mechanism, such as a predetermined activation key on the keypad portion of the user device 12. Optionally, user interface 38 makes available the option to the subscriber to scan and examine the records stored in the service usage log file 32 in order to obtain information about service sessions performed. User data records builder component 30 is coupled to the service usage log file 32. Component 30 processes the records stored in the service usage log file 32 on a periodic basis, generates user data records based on the service usage log file 32 records, and inserts the user data records into the user data records file 36. User data records file 36 is an internal data structure installed in a memory device of the user device 12 and coupled to the user data record builder component 30. The records included in the user data records file 36 are transmitted periodically to the bill verification device 26 via the operation of the user data records transmitter component 42 which is coupled to the communication device 44. As a non-limiting example, the transmission could be implemented in the framework of SMS messaging. Accordingly, the records could be embedded within the body of an SMS message and the message could be transmitted to the device 26. The operation of the component 42 is initiated by the transmission scheduler component 40 coupled to the user interface 38. The operation could be initiated either in accordance with pre-defined transmission scheduling parameters or directly by transmission commands submitted by the subscriber associated with the user device 12 via the user interface 38. The transmission commands could be generated consequent the manipulation of pre-defined activation keys on the keypad portion of the user device 12 by the subscriber operating the device. Communication device 44 is a built-in hardware device, such as transceiver and an associated antenna operating in conjunction with a standard communication device driver. Device 44 is responsible for the establishment and maintenance of the physical communication link between the user device 12 and the service provider device 18 on the one hand, and the bill verification device 26 on the other hand. Both links are set up via the mobile communication network and/or a local or wide area data communication network connected to the mobile network via specific inter-network gateway devices.

Still referring to FIG. 2 note should be taken that the structure and content of the service usage log records stored in the service usage log file 32 could be substantially similar to the structure and content of the call data records (CDR) generated by the service provider site. In the same manner, the structure and content of the user data records stored in the user data records file 36 could be substantially similar to the structure and content of the processed call data records (CDR) that are transmitted to the billing system by the service provider device 18. Both the processed call data records generated by the service provider device 18 and the user data records built by the user data records builder component 30 of the user device 12 include detailed information about the service session, such as a mobile telephone call. A more detailed description of the structure and the constituent fields of the user data records will be set forth herein under in association with the following drawings. Further note should be taken that above-described configuration of the user device 12 is exemplary only. Various functionally equivalent components could be added to the user device 12; some component could be combined while other components could be omitted while allowing to obtain the objects of the invention. For example, the transmission scheduler component 40 could be dispensed with and each user data records transmission could be initiated and activated manually by the subscriber via the user interface 38. In an another example, a user data records deleter component could be added to the device 12 to prevent overflowing of the memory device that is used for the storage of the user data records. Another useful component could be a “user data records storage low” warning component that could notify the subscriber when the number of user data records kept in the memory device reaches a pre-defined limit.

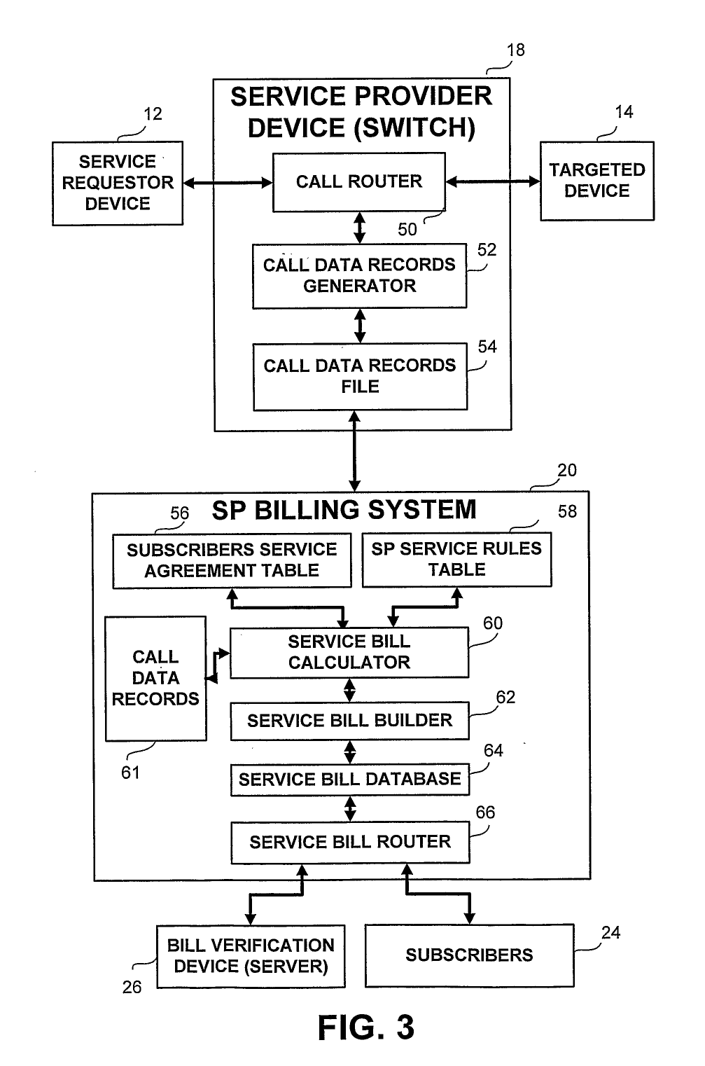

Referring now to FIG. 3 in the first preferred embodiment of the present invention, the service provider device 18 is a mobile telephony switch set up, maintained and operated by a mobile service provider. The primary objective of the switch 18 is to establish, maintain, manage, and control communication sessions, i.e. mobile voice calls or data calls between a service requestor device 12, such as a first mobile phone and a targeted device 14, such as a second mobile telephone device. Service provider device 18 includes a call router 50, a call data records generator 52, and a call data records file 54. Call router 50 is responsible for the routing of the calls in response to the call requests received from the service requestor device 12. Note should be taken that although the drawing under discussion shows only a limited number of service requestor devices and targeted devices it would be easily understood that in a realistic environment a plurality of service requestor devices could submit a plurality of call requests to a plurality of targeted devices substantially simultaneously. Call router 50 relays call information for each communication session to the call data records generator 52. Call data records generator creates call data records and inserts the call data records to the call data records file 54 for storage. Thus, the switch 18 maintains one or more call data records (CDRs) for each mobile telephony call the switch is involved in handling. Each CDR contains substantially all the information regarding the mobile calls handled by the switch, such as cell site, duration, start date, start time, and the like. Note should be taken that each manufacturer could use a different proprietary format for the CDRs generated by the switch. Moreover, different types of switches of the same manufacturer could also use different format CDRs. In order to produce service bills on a periodic basis (typically on a monthly basis) the call data records file 54 is transferred to a service provider billing system 20. Billing system 20 is a server containing a set of logically inter-related computer programs and associated data structures containing billing control information. Billing system 20 is typically installed on a dedicated or shared computing platform installed in a data communication network and linked to the service provider device 18 installed in the mobile network via specific inter-network gateway devices. One such billing system is the Ensemble product manufactured and distributed by Amdocs Ltd. Based in St. Louis, Mo. USA. Billing system 20 typically includes a subscriber service agreement table 56, a service provider rules table 58, a service bill calculator 60, a service bill builder 62, a call data records file 61, a service bill database 64, and a service bill router 66. Billing system 20 is communicatively linked via the communication network to the bill verification device 26, and to the service subscribers 24 via traditional communications channels, such a standard mail, e-mail, and the like.

Still referring to FIG. 3, the billing system 20 holds service subscriber information, such as user device identification, name, address, and the like. The subscriber information is utilized for billing purposes. Subscriber service agreement table 56 stores service contracts that define contract terms or rules agreed upon by the service provider and the subscriber. For example, the service agreement could store a pre-defined charge for a pre-defined call period. The agreement could also store a pre-defined charge for the sending of an SMS message, for the number of non-chargeable SMS messages, the cost of the data usage, and diverse other financial information regarding the calculation of the charges included in the service bill. The service provider rules table 58 stores general control information that could concern the entire subscriber population or a specific segment of the subscriber population and could depend on specific conditions that effect the calculation of the service bill. A non-limiting example concerns subscriber population segments characterized by age groups. Subscribers in lower age groups, such as teenagers, are typically characterized by performing high volume calls and long-duration calls. Thus, members of this age group are typically provided with a service plan that includes lower charges per usage unit in comparison with the members of the other age groups. Service bill calculator 60 calculates and prepares a service bill for a subscriber where the calculation is based on the processed call data records 61 for the same subscriber for the period of the service bill, on the service rules table 58, and on the service agreement table 56. Service bill builder 62 receives calculation results from the service bill calculator 60 and generates a service bill. The service bill is inserted into the service bill database 64. In accordance with pre-defined scheduling parameter values (not shown) a service bill router 66 distributes the service bills to the appropriate targets, such as the subscribers 24 (typically via mail), and optionally to the bill verification device 26 via the communication network. Note should be taken that various billing errors could occur either in the generation of the call data records, in the processing of the call data records, or in the preparation of the service bills. Billing errors can occur when the billing data and the call data records are not in agreement, when, for example, the details of a new service plan are not updated in time. Additional billing errors could occur as a result of errors in the subscriber data, in the subscriber service agreement information, and the like. Yet further billing errors could occur as a result of fraudulent use of the mobile phone number associated with the user device.

Still referring to FIG. 3 note should be taken that the above-described structure and configuration of the service provider switch and service provider billing system is highly schematic and was set forth only for the ready understanding of the invention. In a realistic environment, for example, SMS messages are handled by a Short Message Service Center (SMSC). Detailed information about the SMS message is stored in an SMS message data record and stored on the SMSC. For the preparation of the service bill the Service Provider (SP) billing system 20 obtains the SMS message data records in order to calculate the charges thereof and for incorporating the relevant items into the service bill. In a further example, the billing system 20 typically includes a CDR filtering component that eliminates CDRs of prepaid subscribers, CDRs associated with calls that were not answered, CDRs associated with calls with “busy” signals, and the like.

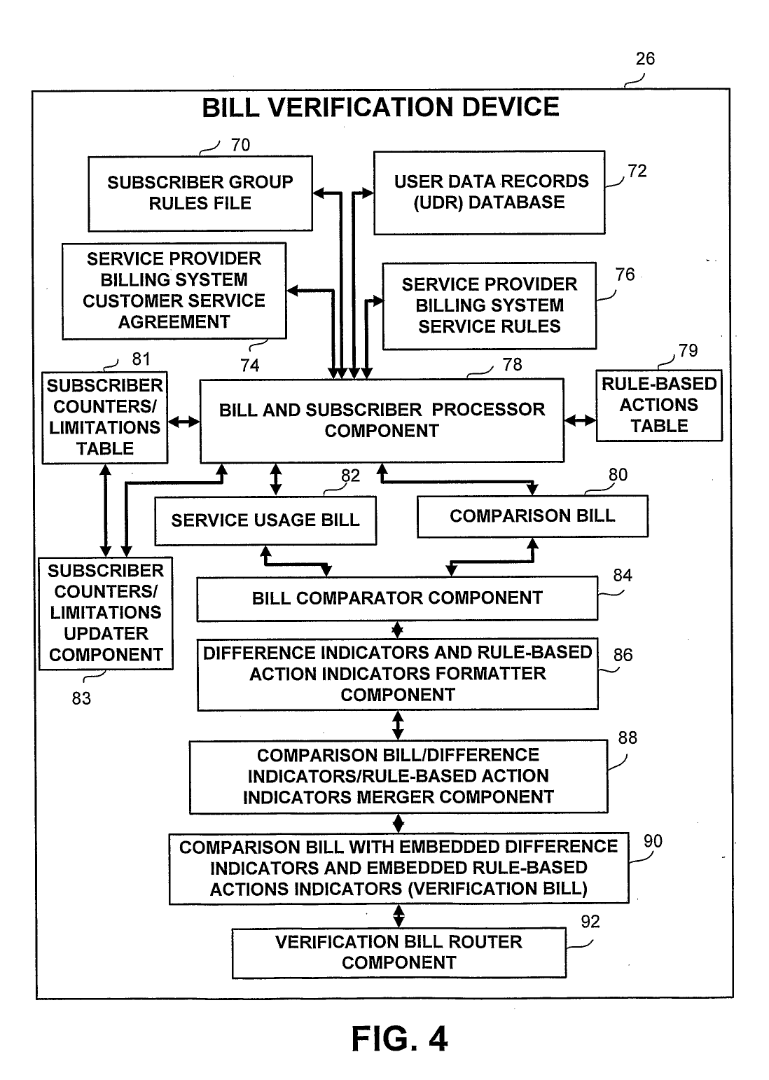

Referring now to FIG. 4 the bill verification device 26 is a group of logically inter-related computer programs and associated control data structures storing bill verification control data. Bill verification device 26 is preferably a server installed on a computing platform linked to a data communications network and indirectly to a mobile telephone network via inter-network gateway devices. Bill verification device 26 could operate within an enterprise for bill verification for the bills of mobile devices used by the employees of the enterprise. Device 26 could also operate as a bill verification server associated with an Internet site that could provide bill verification services to individuals, small business, small offices, and the like. Bill verification server 26 includes a subscriber group rules file 70, a subscriber counter and limitations table 81, a rule-based actions table 79, a user data records (UDR) database 72, a service provider billing system rules table 76, a bill and subscriber processor component 78, a service usage bill 82, a comparison bill 80, a bill comparator component 84, a difference indicators and rule-based action indicators formatter component 86, a comparison bill/difference indicators/rule-based action indicators merger component 86, a comparison bill with embedded difference indicators and rule-based actions indicators (verification bill) 90, a verification bill router component 92, and a subscriber counters/limitations updater component 83. User data records database 72 stores the user data records received from the used device 12, 14, 16 or FIG. 1. Database 72 stores user data records generated on the user device 12, 14, 16 of FIG. 1 and reflect the service usage units associated with the service sessions performed by the user device 12, 14, 16 via the service provider device 18 of FIG. 1. Service provider billing system rules 76 is a data structure that is obtained from the service provider rules table 58 installed in the service provider billing system 20 of FIG. 3. Rules 75 is utilized by the bill verification device 26 for the independent re-calculation and re-generation of a service bill referred to generally as the comparison bill. Service provider billing system customer service agreement 74 is a data structure obtained from the subscriber service agreement table 56 installed on the service provider billing system 20 of FIG. 3. In association with the rules 75 and the user data records from database 72 the service agreement 74 is utilized by the bill verification device 26 for the independent re-calculation and re-generation of a service bill referred to generally as the comparison bill. Subscriber group rules file 70 is a data structure storing pre-defined subscriber and/or subscriber group rule records and utilized optionally to control the usage of the user device 12, 14, and 16 in accordance with pre-defined pre-billing of post-billing conditions. A non-limiting example concerns pre-determined limitations on the number of voice calls and/or SMS messages the subscriber is eligible to perform. Subscriber counters/limitations table 81 is a data structure associated with the file 70. The values and parameters defined and collected in table 81 are utilized for optional control of the pro-billing usage of user device 12, 14, and 16. Subscriber counter/limitations updater component 83 is responsible for the updating of the counter values and/or limit values stored in the file 81 in response to the re-calculated billing information in order to enable selective and optional control the post-billing operation of the user device 12, 14, and 16. Service usage bill 82 is the original bill generated by the service provider billing system 20 of FIG. 3 and transmitted for bill verification from the billing system 20 of FIG. 3 in response to specific requests submitted by the bill verification device 26. Bill and subscription processor component 78 is responsible for generating the comparison bill 80. The comparison bill 80 is generated following the calculation of the billing charges where the calculation is based a) user data records 72, b) billing system rules 76, and c) customer service agreement 74. Component 78 further responsible of obtaining the subscriber-specific or the subscriber-group-specific rules, counter values, limitation values, and the rule-based actions 79 for selecting rule-based and condition-specific action indicators to be merged into the verification bill 90. Bill comparator component 84 compares the independently re-calculated and re-generated comparison bill with the original service provider bill 82 and generates difference indicators that indicate the discrepancies between the two compared bills. Difference indicators and rule-based action indicators formatter component 86 is responsible for the structuring and textual or graphical formatting of the inter-bill difference indicators and the intra-bill rule-based post-billing action indicators. The function of the comparison bill/difference indicators/rule based action indicators merger component 88 is to merge the comparison bill with the inter-bill difference indicators and with the rule-based post-billing action indicators. The comparison bill 80 with embedded and formatted difference indicators and embedded and formatted rule-based post-billing action indicators 90 is referred to as the verification bill. The verification bill 90 is the final product of the bill verification device 26. The verification bill 90 includes the independently re-calculated and re-generated comparison bill 80 the contents of which should be optimally equivalent to the contents of the service usage bill 82. Each discrepancy between the contents of the comparison bill 90 and the service usage bill is indicated in a textual or graphic manner. The verification bill 90 further includes rule-based post-billing action indicators, where the indicators are formatted in a textual or graphical manner and display important post-billing usage limitation information, warning messages, general information messages, and the like. Verification router component 92 is responsible for the routing of the verification bill 90. The bill 90 could be send to various bill examiners, such as the subscribers operating the user devices 12, 14, 16, or to other management personnel. Alternatively, the system can issue a report or notices concerning discrepancies or errors in the bill directly to the service provider. Note should be taken that the structure and configuration of the bill verification server 26 is exemplary only. Diverse additional components and data structures could be used, some data structures and components could be combined while yet other data structures and components could be omitted. For example, the bill and subscriber processor component 78 could be functionally separated in order to form a bill processor component and a subscriber rule engine. In another example, the subscriber group rules file 70 could be combined with the rule-based actions table 79 to form an integrated data structure. In yet another example, a user interface module could be added to the device 26 to allow for system set up, system maintenance, and for program and parameter modifications.

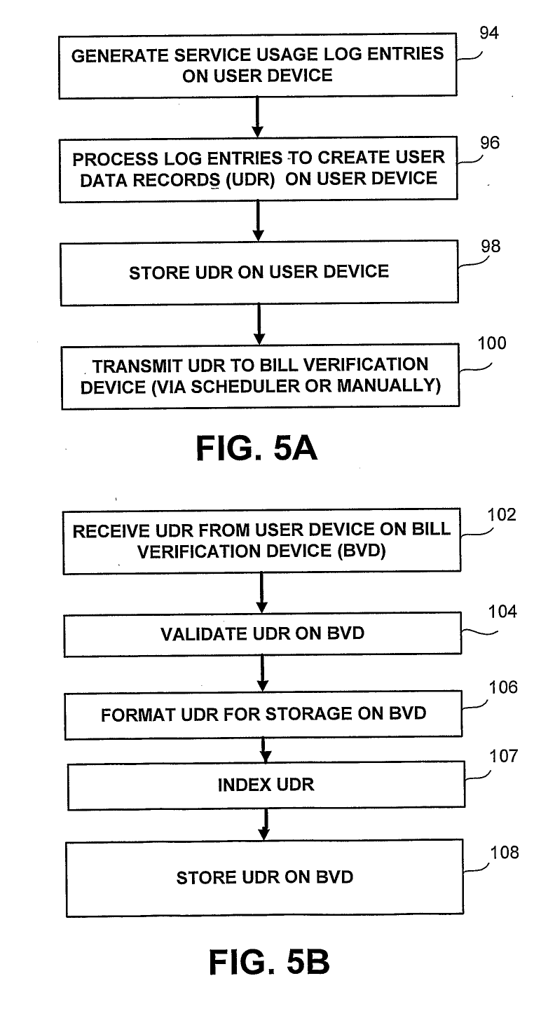

Referring now to FIG. 5A the operating method associated with the user device 12, 14, and 16 of FIG. 1 is described. At step 94 a service one or more usage log entries are generated for each service session performed by the user device 12, 14, 16 of FIG. 1. The structure and content of the service log entries are substantially similar to the structure and content of the call data records created by the service provider device. Both the call data records generated in the service provider device and the usage log entries generated in the user device include specific information regarding a service session, such as a mobile phone call. The service usage log entry records include typically information regarding the originator of the call, including calling party number, and information regarding the called party including dialed number, the date and time of the call, the duration of the call, the status of the call, termination code, and any other desired information regarding the performed service session, such as a mobile phone call. At step 96 the service usage log entries are processed in order to create user data records. The processing could include, for example, filtering out service usage log entries that are associated with incoming calls, with outgoing calls that were not answered, and the like. The process is substantially similar to the processing of the switch-generated call data records by the service provider billing system in preparation to the service bill calculation. At step 98 the user data records are stored in a memory area of the user device. At step 100, in response to an automatic scheduling process or in response to one or more manual commands submitted by the subscriber, the user data records are transmitted from the user device to a bill verification device. The transfer could be accomplished via SMS messaging, infra-red links, or any other type of data transfer method.

Referring now to FIG. 5B the operating method associated with reception of the user data records transmitted by the user device 12, 14, and 16 of FIG. 1 on the bill verification device 26 is described. At step 102 the user data records sent from the user device are received by the bill verification device. At step 104 is user data records are verified in order to ensure that the records are in the proper format and the value of the data fields constituting the records are within acceptable limits. At step 106 the user data records are formatted for storage. At step 107 the user data records are indexed in a suitable manner to enable ready access to the records. The indices used are preferably the user device identification value and the date and time associated with the performance of the service usage units. At step 108 the verified, formatted and indexed user data records are stored in the user data records database on the bill verification server.

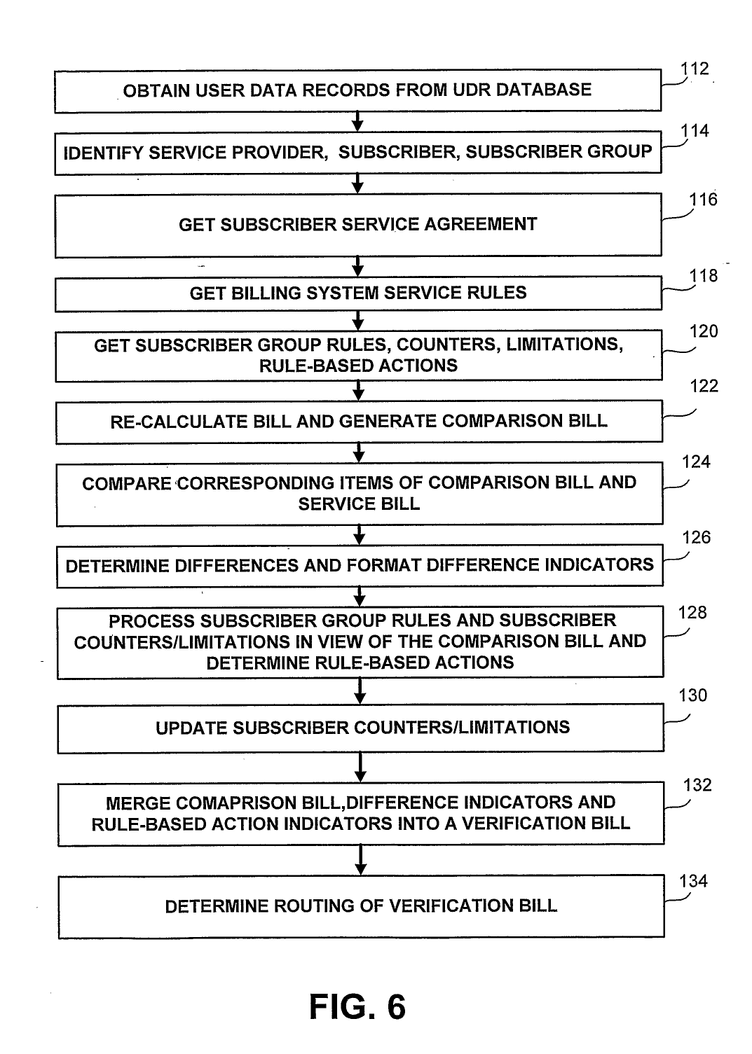

Referring now to FIG. 6, the bill verification process on the bill verification device is described. At step 112 user data records are obtained from user data records database. At step 114 the service provider, the subscriber and the subscriber group are identified. At step 116 the subscriber service agreement is received from the service provider billing system. At step 118 the service provider billing system service rules are obtained from the service provider billing system. Both the service agreement and the service rules can be preferably received in real-time prior to the actual bill calculation in order to provide the most up-to-date control information from the service provider. At step 120 the subscriber group rules, the subscriber counters/limitations, and the rule-based actions are obtained. At step 122 the charges associated with items of the bill are calculated and a comparison bill is generated. At step 124 the corresponding items of the comparison bill and the service bill are compared. At step 126 the inter-bill differences are determined and the difference indicators are formatted to a textual or graphical format. At step 128 the subscriber group rules, subscriber counters and limitations are processed in view of the data within the comparison bill and the rule-based post-billing action indicators are generated and formatted. At step 130 the subscriber counters and/or limitations are updated in accordance with the data within the comparison bill. At step 132 the comparison bill, the formatted intra-bill indicators and the formatted post-billing action indicators are merged into a verification bill. At step 134 the routing of the verification bill is determined and the verification bill is distributed to the suitable recipients. Note should be taken that the above-described method is exemplary only. In other preferred embodiments different steps could be implemented, the order of steps could be modified, some steps could be dispensed with and other steps could be added. The limits of the invention are defined only by the attached claims.

The first preferred embodiment of the present invention regards mobile service bill verification in a mobile telephone network. The underlying principles of the proposed invention provide the basis for the implementation of additional useful embodiments for applications where periodic bills are prepared and the calculation is based on service usage records generated in real-time. In accordance with the underlying principle of the present invention the service usage bills will be verified by independently calculating a comparison bill and by comparing the comparison bill to the original bill. The re-calculated comparison bills with suitably embedded discrepancy indicators would be provided to the appropriate recipients. Thus, a second preferred embodiment of the present invention will be described next.

In the second preferred embodiment of the present invention the user device is an enhanced credit card having internal dynamic storage capabilities. The enhanced credit card is a plastic card with an embedded microchip that can be loaded with data. The enhanced credit card could be used for telephone calling, electronic cash payments, and other applications, and then periodically refreshed for additional use. Alternatively the enhanced credit card could be used to dial a connection on a mobile telephone and be charged on a per-call basis, to establish user identity when logging on to an Internet access provider or to an online bank, to pay for parking at parking meters or to get on subways, trains, or buses, to give hospitals or doctors personal data without filling out a form, to make small-purchases at electronic stores on the Web, to buy gasoline at a gasoline station, and the like. In the second preferred embodiment of the present invention, the enhanced credit card is used for the performance of commercial transactions. The enhanced credit card is “swiped” or passed through a credit card reader device associated with a credit-based transaction initializer, manager, and controller device. The basic credit card information, such as the card identification, valid date, and the like, is transmitted from the transaction manager device via a credit network to a credit service provider site. The credit service provider site performs routine card authentication, card authorization, credit authorization, and the like, and verifies the transaction by sending suitable indication back to the transaction controller device. When the transaction is finalized a credit-based transaction record is generated on the credit service provider device to be used subsequently for the preparation of a periodic credit service bill. Substantially simultaneously a similar credit transaction record is generated by the credit-based transaction controller device and the credit transaction record is written into a dynamic memory area of the enhanced credit card. For each credit-based transaction one or more credit transaction records are generated and the set of records are collected in the dynamic memory area of the enhanced credit card. Subsequent to the reception of a credit service bill from the credit service provider the collected credit transaction records are transferred to a credit service bill verification device. The transfer of the records could be done via the operation of an enhanced card reader device operating in association with a computing device. The enhanced card reader device receives the credit-based transaction records from the dynamic memory of the enhanced credit card and relays the records to a credit service bill verification device. The verification device accesses the credit service provider site in order to receive the suitable credit bill and the associated control information. Subsequently credit comparison bill is independently calculated and generated by the credit bill verification device where the calculation is based a) on the original credit service bill, b) credit-bill calculation control information from the credit service provider, and c) credit-based transaction records obtained from the enhanced credit card. The calculated comparison bill is compared to the original credit bill and suitable discrepancy indicators are generated. The comparison bill and the discrepancy indicators are merged to form a verification bill that is suitably routed to the appropriate recipients, such as the enhanced credit card owner, the credit card-service provider, and the like.

It will be appreciated by persons skilled in the art that the present invention is not limited to what has been particularly shown and described hereinabove. Rather the scope of the present invention is defined only by the claims which follow.

1. In a communications and computing environment an apparatus for verifying an at least one service bill issued to an at least one subscriber by a service provider, the apparatus comprising the elements of:
an at least one user device associated with the at least one subscriber, for generating an at least one user data record describing an at least one usage unit of a service provided by the service provider;
an at least one bill verification device for receiving and storing bill calculation and bill generation information from the at least one user device and from an at least one service provider, and for calculating and generating an at least one comparison bill, to compare with the at least one service bill issued by the service provider;
wherein the results of the comparison in the bill verification device generate difference indicators, which indicate differences between the comparison bill and the service usage bill issued by the service provider; and wherein the difference indicators are merged into the comparison bill to form a verification bill, which is provided by the at least one bill verification device.

2. The apparatus of claim 1 wherein the at least one user device is a mobile telephone communication device.

3. The apparatus of claim 2 wherein the at least one user device is a communications-enabled Personal Digital Assistance device.

4. The apparatus of claim 3 wherein the at least one user device is an enhanced credit card having dynamic data storage capabilities.

5. The apparatus of claim 1 wherein the at least one user device comprises the elements of:
a service handler component for initiating and for performing service usage, for generating an at least one service usage unit associated with the service usage, and for storing the at least one service usage unit;
a service usage log file held in an internal memory device of the at least one user device and coupled to the service handler component for storing service usage information generated via service usage;
a user data record builder component coupled to a service usage log file for creating an at least one user data record based on the service usage file and carrying information based on an at least one least usage unit of a service provided by the service provider;
a user data records file held in the internal memory device of the at least one user device and coupled to the user data record builder component for storing the at least one user data record generated by the user data record builder component;
a transmission scheduler component coupled to a user interface for receiving and for holding transmission scheduling control information and for activating a user data record transmission process by sending activation commands in response to transmission scheduling control information;
a user data records transmitter component coupled to a communications device for transmitting user data records to a bill verification device in response to the activation commands received from the transmission scheduler component.

6. The apparatus of claim 5 wherein the at least one user device further comprises a user interface for enabling communication between the at least one user device and an at least one subscriber operating the at least one user device.

7. The apparatus of claim 1 wherein the at least one bill verification device comprises the elements of:
a user data records database held in an internal memory device of the at least one bill verification device for storing user data records transmitted from the at least one user device;
a service provider billing system rules file for storing billing system rules obtained by the at least one bill verification device from the at least one service provider device;
a service provider billing system subscriber service contract file for storing subscriber contract information obtained by the at least one bill verification device from the at least one service provider device;
a subscriber rules and subscriber group rules file for holding subscriber-specific and subscriber-group-specific control data;
a service usage bill issued by the service provider billing system device;
a bill and subscriber processor component for calculating and generating a comparison bill and for processing subscriber and subscriber group control information;
a bill comparator component to compare between the comparison bill and the service usage bill issued by the service provider billing system;
a billing difference and subscriber and subscriber group rule based indicators formatter component for formatting the results generated by the bill and subscriber processor component and the bill comparator component;
a merger component for merging the difference indicators and the subscriber and the subscriber group rule based indicators into the comparison bill and for generating a verification bill resulting from the merging process;
a verification bill for displaying the detailed billing charges information calculated internally, the difference indicators between the comparison bill and the bill issued by the service provider billing system, and the subscriber and the subscriber group rule-based indicators.

8. The apparatus of claim 7 wherein the at least one bill verification device further comprises the elements of:
a subscriber rules-based and subscriber group rules-based actions table for storing rules-based actions to be performed in response to the identification of post-billing conditions defined by the combination of rules, counter values and limitation values;
a subscriber control file for storing subscriber counters and subscriber limitations;
a subscriber control file updater for updating subscriber counters in response to results generated by the bill and subscriber processor component;
a verification bill router component for routing the verification bill to an at least one pre-defined subscriber.

9. The apparatus of claim 1 wherein the at least one subscriber is a network-based service subscriber.

10. The apparatus of claim 1 wherein the at least one service provider is a network-based service provider.

11. The apparatus of claim 1 wherein the at least one service provider is a Mobile Communications Service Provider.

12. The apparatus of claim 11 wherein the at least one service provider is a credit-based purchasing and payment service provider.

13. The apparatus of claim 1 wherein the service provided by the at least one service provider to the at least one subscriber is a mobile telephone communication service.

14. The apparatus of claim 13 wherein the service provided by the at least one service provider to the at least one subscriber is a goods or services purchasing service associated with credit accounts and credit cards.

15. The apparatus of claim 1 wherein the at least one bill verification device is a bill verification server installed on a computing platform linked to the communications network.

16. The apparatus of claim 1 further comprises the elements of:
a service provider device linked to the communication network, for responding to service requests submitted by the at least one user device, for managing and maintaining service usage associated with the submitted requests, for generating call data records associated with service usage units, and for transmitting accumulated call data records for service usage bill generation;
a service provider billing system coupled to the service provider device for storing subscriber contract information, for storing service provider rules, for calculating and generating service usage bills, and for responding to requests submitted by the at least one bill verification device by transmitting subscriber contract information and service provider rules information to the at least one bill verification device.

17. The apparatus of claim 16 wherein the service provider device is a mobile network switch device.

18. The apparatus of claim 17 wherein the service provider device is a credit card authorization, credit card authentication, and credit-based transaction clearance device.

19. The apparatus of claim 18 wherein the service provider billing system is a billing system installed on a computing platform.

20. The apparatus of claim 1 wherein the at least one user data record comprises:
a user device identification field for identifying the at least one user device and the associated at least one subscriber;
a service type indicator field to identify the type of service associated with the usage unit reflected by content of the at least user data record;
a length of use field for providing calculation-specific information to the bill and subscriber processor component;
a service provider identification field for building communication address to the service provider device and for connecting the contract and service provider information to the bill and subscriber processor component; and
a date and time field for user data record identification and for date and time dependent calculations.

21. The apparatus of claim 1 wherein the at least one user device is connectable to a communications network.

22. The apparatus of claim 1 wherein the at least one user device transmits the at least one user data records for bill verification.

23. The apparatus of claim 1 wherein the at least one bill verification device is linked to a communication network.

24. The apparatus of claim 1 wherein the at least one service provider device is linked to a communications network.

25. The apparatus of claim 1 wherein the at least one bill verification device locates potential differences between the at least one comparison bill and the at least one service usage bill.

26. The apparatus of any claims 2, 3 or 4 wherein the communications network is a mobile telephone communications network.

27. The apparatus of claim 26 wherein the communications network is a data communications network.

28. The apparatus of claim 27 wherein the communications network is a credit network.

29. In a communications and computing environment a method for verifying an at least one service usage bill associated with a service and issued to an at least one subscriber by a service provider, the method comprising the steps of:
building an at least one user data record in an at least one user device, the content of the record reflecting an at least one usage unit associated with a service provided by the service provider;
transmitting the at least one user data record to the at least one bill verification device from the at least one user device;
obtaining an at least one service usage bill from a service provider billing system in the at least one bill verification device;
requesting and receiving service usage bill calculation and bill generation control data from the service provider billing system in the at least one bill verification device;
generating a comparison bill based on the bill calculation and generation control data in the at least one bill verification device;
comparing the comparison bill with the service usage bill in the at least one bill verification device;
determining differences between the comparison bill and the service usage bill in the at least one bill verification device; and
generating difference indicators and merge the comparison bill and the difference indicators into a verification bill in the at least one bill verification device.

30. The method of claim 29 further comprises activating a data transmission process via a scheduling component or via a manual mechanism for providing periodic user data record transmission from the at least one user device to the at least one bill verification device.

31. The method of claim 29 further comprises generating a service usage log file in the at least one user device in response to service usage.

32. The method of claim 29 further comprises the steps of:
reading the subscriber rules, the subscriber group rules, the subscriber counter values and the subscriber limitation data in the at least one bill verification device;
processing the subscriber rules, the subscriber group rules in association with the subscriber counter information, the subscriber limitation information, and the comparison bill data in the at least one bill verification device; and
generating subscriber and subscriber group rule-specific action indicators based on the rule-based actions in the at least one bill verification device.

33. The method of claim 29 further comprises routing the verification bill to an at least one subscriber in the at least one bill verification device.

34. The method of claim 29 further comprises updating subscriber counters and subscriber limitation data based on the content of the comparison bill in the at least one bill verification device.

35. The method of claim 29 wherein the service provided by the service provider is a mobile telephone communication service.

36. The method of claim 29 wherein the at least one user data record is generated in response to the performance of incoming calls, outgoing calls, SMS message transmission, credit card transactions, and data communications network access.

37. The method of claim 36 wherein the at least one user data record transmitted from the at least one user device to the at least one bill verification device via SMS messages.

38. The method of claim 37 wherein the at least one user data record is transmitted from the at least one user device to the at least one bill verification device via infra-red links.

39. The method of claim 38 wherein the at least one user data record is transmitted from the at least one user device to the at least one bill verification device via a credit card reading device linked communicatively to the at least one bill verification device.
